(19) United States
(12) Patent Application Publication
(10) Pub. No.: US 2025/0315545 A1
(43) Pub. Date: Oct. 9, 2025

(54) Securing End User Access To Application Databases

(71) Applicant: Google LLC, Mountain View, CA (US)

(72) Inventors: Yannis Papakonstantinou, La Jolla, CA (US); Sam Idicula, Santa Clara, CA (US); Pranav Nambiar, Redmond, WA (US); Saileshwar Krishnamurthy, Palo Alto, CA (US); Shreedhar Hardikar, San Mateo, CA (US); Noah Jeffrey Misch, Sunnyvale, CA (US); Per Jacobsson, Sunnyvale, CA (US); Haoyu Huang, Fremont, CA (US); Andrew Lee Brook, Redwood City, CA (US)

(21) Appl. No.: 19/171,453

(22) Filed: Apr. 7, 2025

Related U.S. Application Data
(60) Provisional application No. 63/631,145, filed on Apr. 8, 2024.

(30) Foreign Application Priority Data
Apr. 8, 2024 (GR) 20240100261

(51) Int. Cl. G06F 21/62; G06F 16/2452

(52) U.S. Cl. CPC G06F 21/6227; G06F 16/24522

(57) ABSTRACT

The technology generally relates to securing end user access to application databases. An application receives a natural language query from an application end user requesting particular data from a database. The application identifies one or more tokens associated with the application end user to identify the application-specific data that is accessible to the application end user. The application provides the one or more tokens to one or more parameterized secure view elements. The parameterized secure view elements use the one or more tokens to create a virtual database that contains only the application-specific data that is accessible to the application end user. The application uses one or more machine learning models to translate the natural language query into a database query that the application uses to access the virtual database and retrieve the particular data to respond to the natural language query.

### CROSS-REFERENCE TO RELATED APPLICATIONS

The present application claims the benefit of the filing date of U.S. Provisional Patent Application No. 63/631,145, filed Apr. 8, 2024, and claims priority from Greek Patent Application No. 20240100261, filed Apr. 8, 2024, the disclosures of which are hereby incorporated herein by reference.

### BACKGROUND

Some modern day services allow users to access application-specific data stored in one or more databases. The application-specific data may be associated with an application that is configured to receive natural language (NL) queries. The NL queries are transmitted from a user computing device to a server or cloud network hosting the application. The application may use one or more language modeling techniques, such as large language models (LLMs), to parse and analyze the NL queries. For instance, an LLM can use NL-to-structured-query-language (SQL) (NL2SQL) translation techniques to generate one or more SQL queries that capture the NL queries. The application can then use the SQL queries to retrieve the application-specific data from the databases. However, current NL2SQL techniques for accessing the application-specific data are not equipped to detect instances where NL queries are directed to seek access to data that a particular user is not authorized to access. This results in data security concerns, since NL queries may be used to manipulate the LLM into providing unauthorized access to data or otherwise compromise data security.

### SUMMARY

Aspects of the disclosure are directed to securing end user access to application databases. An application receives a natural language (NL) query from an application end user. The application identifies one or more tokens associated with the application end user. The one or more tokens identify application-specific data in an application database that is accessible to the application end user. The application provides the one or more tokens to one or more parameterized secure view elements. The parameterized secure view elements operate as a security frontend to the application database to limit access to application-specific data so that application end users can only access the application data to which they are permitted. The application database contains application data that belongs to a plurality of application end users. The parameterized secure view element uses the one or more tokens to create a virtual database, also referred to as a view, that contains only the application data that the application end user is permitted to access. The application can then use one or more large language models (LLMs) to perform NL-to-structured query language (SQL) (NL2SQL) translation to generate one or more SQL queries that the application uses to access the virtual database. The parameterized secure view element thus allows for NL2SQL translation without concerns that the translation will result in a user accessing data to which they are not permitted.

An aspect of the disclosure provides for a method of securing end user access to an application database, the method including: receiving, by one or more processors, a natural language query from an application end user requesting access to particular data in an application database; identifying, by the one or more processors, an identifier associated with the application end user; generating, by the one or more processors, based on the identifier, a virtual database containing application-specific data from the application database that the application end user is permitted to access; translating, by the one or more processors, the natural language query to a database language query; retrieving, by the one or more processors, using the database language query, the particular data from the virtual database; and outputting, by the one or more processors, the particular data to the application end user to respond to the natural language query.

Another aspect of the disclosure provides for a system including: one or more processors; and one or more storage devices coupled to the one or more processors and storing instructions that, when executed by the one or more processors, cause the one or more processors to perform operations for the method for securing end user access to an application database. Yet another aspect of the disclosure provides for a non-transitory computer readable medium for storing instructions that, when executed by one or more processors, cause the one or more processors to perform operations for the method for securing end user access to an application database.

In some examples, the natural language query is translated to the database language query using a machine learning model. In some examples, the machine learning model is a large language model. In some examples, the database language is structured query language. In some examples, the identifier is at least one of a token, numerical value, string value, or bit value. In some examples, the identifier is a composite of two or more identifiers.

In some examples, the method further includes generating, by the one or more processors, the identifier based on the application end user being authenticated. In some examples, the method further includes: receiving, by the one or more processors, a second natural language query from the application end user requesting access to unauthorized data in the application database; translating, by the one or more processors, the second natural language query to a second database language query; attempting, by the one or more processors, using the second database language query, to retrieve the unauthorized data from the virtual database; determining, by the one or more processors, that the unauthorized data is not in the virtual database; and outputting, by the one or more processors, an empty response or an error message to the application end user to respond to the second natural language query.

### BRIEF DESCRIPTION OF THE DRAWINGS

FIG. 1 depicts an example application system for securing end user access to application databases according to aspects of the disclosure.

FIG. 2 depicts a block diagram of an example environment implementing the application system for securing end user access to application databases according to aspects of the disclosure.

FIG. 3 depicts a flow diagram of an example process for securing end user access to application databases according to aspects of the disclosure.

FIG. 4 depicts a flow diagram of an example process for denying end user access to unauthorized data according to aspects of the disclosure.

### DETAILED DESCRIPTION

The technology generally relates to securing end user access to application databases. Application end users can interact with one or more applications, e.g., mobile applications, browser-based applications, or the like. The applications can be configured to accept user input as natural language (NL) queries. The NL queries can be directed toward accessing application-specific data in an application database. A unique identifier, e.g., token or value, is associated with each user and identifies the application-specific data that is accessible to respective users. The unique identifier may be a composite of two or more identifiers. A parameterized secure view element can use the unique identifier to identify what the user is permitted to access, e.g., identify the application-specific data accessible to the user. The parameterized secure view element serves as a security frontend or overlay to the application database. The parameterized secure view element limits user access to the application-specific data in the application database based on the unique identifier. Specifically, the parameterized secure view element generates a virtual database containing only the application-specific data that the user is permitted to access and provides the application access to the virtual database. The application may then use one or more large language models (LLMs) to translate the NL queries into one or more database queries for accessing the application-specific data in the virtual database. The user is thus not able to access information of other users and/or other types of information that the user is not permitted to access.

For example, a first user is permitted to access purchase history information associated with the first user's account but is not permitted to access purchase history information associated with a second user's account. However, there is a risk that the first user could access the second user's purchase history through LLM processing of NL queries, specifically in translating an NL query to an SQL query. Therefore, the application identifies a unique identifier associated with the first user and provides the identifier to a parameterized secure view element associated with an application database. The parameterized secure view element uses the identifier to identify application-specific data in the database that the first user is permitted to access and generates a virtual database containing the identified application-specific data. The application uses one or more LLMs to translate the NL query into one or more database queries, e.g., SQL queries, that are issued to the virtual database to retrieve only the purchase history information that the first user is permitted to access.

A user typically logs into an application via one or more user authentication methods. For example, a user may enter a username and password combination, perform biometric authentication, e.g., fingerprint scan, iris scan, and/or facial recognition, use multi-factor authentication, and/or use certificate-based authentication. In response to the user being authenticated, an identifier is generated that identifies the application data that the user is permitted to access. For example, the user identifier used for logging into the application may be the identifier that is used as a view parameter to identify the application-specific data accessible to the user. As another example, when a manager, e.g., MsManager1@google.com, logs into the application with login name MsManager1 and some password, the view parameter, which specifies what data is accessible, may be a manager identifier mgr_id that corresponds to MsManager1. However, mgr_ids may be unique only within divisions of a company. For example, AnotherManager3@google.com may have the same mgr_id but a different division identifier division_id. In this case, a parameterized secure view element will take into account two parameters: manager identification mgr_id and division identification division_id. In doing so, the parameterized secure view element looks for composite identifiers, such as [mgr_id, division_id]. As yet another example, multiple application end users may have access to the same data and thus may be associated with the same identifiers. For example, in a company, every employee of a department may have full access to the data of the department but not to data of other departments. In this case, the identifier that matters to the parameterized secure view is the division identifier division_id. Therefore, each user is associated with an identifier or combination of identifiers. The identifiers are used to identify the part of the application-specific data to which each user has access. In some examples, a plurality of users can have identical identifiers. The application identifies at least one identifier associated with a user and provides the identifier to one or more parameterized secure view elements that serve as an interface to the application database. The parameterized secure view elements use the identifier to identify the application data that the user is permitted to access.

The user may submit one or more NL queries to the application to access application-specific data. In order to respond to the NL queries with the application-specific data, the application may access one or more tables in an application database, where the one or more tables contain the requested application-specific data. The parameterized secure view elements expand the security measures within application databases. The parameterized secure view elements virtually gather the application-specific data that the user is permitted to access into a virtual database. The virtual database and/or the application-specific data within the virtual database may or may not be persisted in storage. The virtual database contains at least a subset of the application-specific data stored in the application database. The virtual database contains a safe set of data to which access is permitted only to the user associated with the identifier or composite of identifiers that was used to generate the virtual database. Virtual databases thus may contain different application-specific data for different users associated with different identifiers. As such, each virtual database provides a safe view of the application-specific data associated with respective users. The parameterized secure view elements provide the application with the virtual database to allow the application to respond to NL queries generated by the user.

The application may use one or more LLMs to perform NL2SQL translation on the NL query generated by the user to generate one or more SQL queries that can be used to access the virtual database. The one or more SQL queries identify application-specific data in the virtual database that satisfies the NL queries and the application provides the identified application-specific data to the user. When a user seeks to access data that the user is not authorized to access, that data will not be in the virtual database created based on that user's identifier. Thus, the application may generate an empty response.

Aspects of the disclosure thus allow for secure end user access to application databases. An identifier associated with a user indicates the database data that the user is permitted to access. Parameterized secure view elements that overlay an application database use the identifiers to enforce access restrictions on the application database. The parameterized secure view elements use the identifiers to generate a virtual database to provide the application with only application-specific data that the user is permitted to access. The application may use the virtual database to respond to a user request to access the application-specific data.

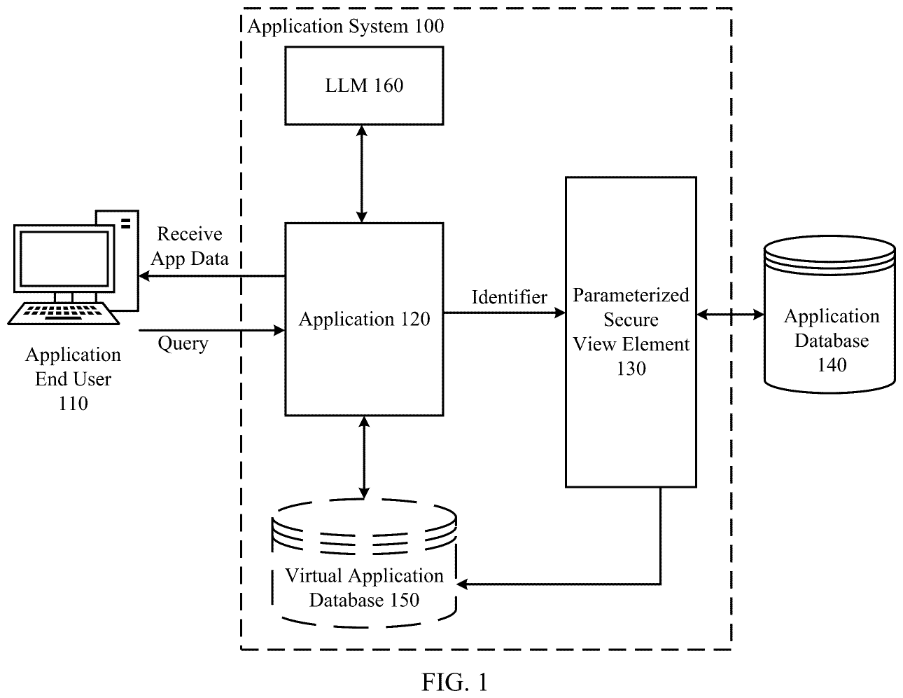

FIG. 1 depicts an example application system 100 for securing end user access to application databases. The application system 100 can be in communication with one or more application end users 110 and one or more application databases 140. The application system 100 can include one or more applications 120, one or more parameterized secure view elements 130, one or more virtual application databases 150, and one or more large language models (LLMs) 160. While shown separately, the application databases 140 may be included as part of the application system 100.

The application end user 110 can be one or more computing devices configured to query the application 120 to access application-specific data in the application database 140. The query can be an NL query. The application end user 110 may access application programming interfaces (APIs) and/or user interfaces (UIs) associated with the application 120 to communicate with the application 120. The application end user 110 may generate NL queries directed to accessing application-specific data stored in the application database 140. The application end user 110 may transmit the NL queries to application 120. The application 120 may be hosted in a cloud network environment, where the application end user 110 is configured to communicate with the application 120 via the cloud network.

The application 120 can be any application that interfaces with end users, including banking applications, e-commerce applications, and/or gaming applications, as examples. The application 120 receives NL queries from the application end user 110 and, in response, identifies an identifier associated with the application end user 110. The identifier can indicate access permissions associated with the application end user 110, such as access permissions for tables and/or view of the application-specific data in the application database 140. Example identifiers can include tokens and/or values, e.g., numerical, string, and/or bit values. The identifier can be a composite of two or more identifiers.

The application 120 can provide the identifier to the parameterized secure view element 130. The parameterized secure view element 130 uses the identifiers to identify application-specific data in the application database 140 that the application end user 110 is permitted to access. For example, tables of the application-specific data may have a column or row for identifiers to be associated with entries in the table. The parameterized secure view element 130 can identify any entries in the table that are associated with the identifiers for the application end user 110. The parameterized secure view element 130 can retrieve the application-specific data that the application end user 110 is permitted to access and generate the virtual application database 150 from the retrieved application-specific data. The parameterized secure view element 130 can provide the virtual application database 150 to the application 120.

The application 120 uses the virtual application database 150 to respond to the NL query. The application 120 can perform a NL to database language translation, such as by using the LLM 160, to translate the NL query to a database language query, e.g., SQL query. The application 120 uses the SQL query to retrieve application-specific data from the virtual application database 150. The application 120 responds to the NL query by providing the application-specific data to the application end user 110.

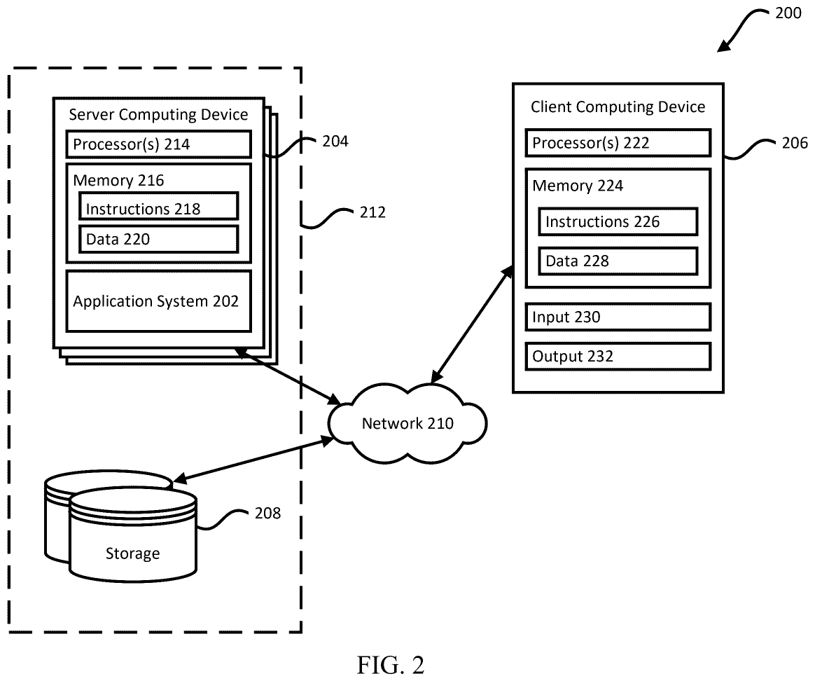

FIG. 2 depicts a block diagram of an example environment 200 implementing the application system 202 for securing end user access to application databases. The application system 202 can correspond to the application system 120 as depicted in FIG. 1. The application system 202 can be implemented on one or more devices having one or more processors in one or more locations, such as in a server computing device 204. A client computing device 206 and the server computing device 204 can be communicatively coupled to one or more storage devices 208 over a network 210. The client computing device 206 can correspond to the application end user 110 as depicted in FIG. 1 and the one or more storage devices 208 can correspond to the application database 140 as depicted in FIG. 1.

The server computing device 204 and the storage devices 208 can form part of a cloud computing system 212 for cloud computing services such as Infrastructure as a Service (IaaS), Platform as a Service (PaaS), and/or Software as a Service (SaaS). For example, the client computing device 206 may use the cloud computing system 212 as a service that provides software applications, such as accounting, word processing, inventory tracking, fraud detection, file sharing, video sharing, audio sharing, communication, or gaming. As another example, the client computing device 206 can access the cloud computing system 212 as part of one or more operations that employ machine learning, deep learning, and/or artificial intelligence technology to train the software applications. The cloud computing system 212 can provide model parameters that can be used to update machine learning models for the software applications.

The storage devices 208 can be a combination of volatile and non-volatile memory and can be at the same or different physical locations than the computing devices 204, 206. For example, the storage devices 208 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 204 can include one or more processors 214 and memory 216. The memory 216 can store information accessible by the processors 214, including instructions 218 that can be executed by the processors 214. The memory 216 can also include data 220 that can be retrieved, manipulated, or stored by the processors 214. The memory 216 can be a type of non-transitory computer readable medium capable of storing information accessible by the processors 214, such as volatile and non-volatile memory. The processors 214 can include one or more central processing units (CPUs), graphic processing units (GPUs), field-programmable gate arrays (FPGAs), and/or application-specific integrated circuits (ASICs), such as tensor processing units (TPUs).

The instructions 218 can include one or more instructions that when executed by the processors 214, cause the one or more processors to perform actions defined by the instructions 218. The instructions 218 can be stored in object code format for direct processing by the processors 214, or in other formats including interpretable scripts or collections of independent source code modules that are interpreted on demand or compiled in advance. The instructions 218 can include instructions for implementing the application system 202. The application system 202 can be executed using the processors 214, and/or using other processors remotely located from the server computing device 204.

The data 220 can be retrieved, stored, or modified by the processors 214 in accordance with the instructions 218. The data 220 can be stored in computer registers, in a relational or non-relational database as a table having a plurality of different fields and records, or as JSON, YAML, proto, or XML documents. The data 220 can also be formatted in a computer-readable format such as, but not limited to, binary values, ASCII, or Unicode. Moreover, the data 220 can include information sufficient to identify relevant information, such as numbers, descriptive text, proprietary codes, pointers, references to data stored in other memories, including other network locations, or information that is used by a function to calculate relevant data.

The client computing device 206 can also be configured similarly to the server computing device 204, with one or more processors 222, memory 224, instructions 226, and data 228. The client computing device 206 can also include a client input 230 and a client output 232. The client input 230 can include any appropriate mechanism or technique for receiving input from a client, such as keyboard, mouse, mechanical actuators, soft actuators, touchscreens, microphones, and sensors.

The server computing device 204 can be configured to transmit data to the client computing device 206, and the client computing device 206 can be configured to display at least a portion of the received data on a display implemented as part of the client output 232. The client output 232 can also be used for displaying an interface between the client computing device 206 and the server computing device 204. The client output 232 can alternatively or additionally include one or more speakers, transducers or other audio outputs, a haptic interface or other tactile feedback that provides non-visual and non-audible information to a client of the client computing device 206.

Although FIG. 2 illustrates the processors 214, 222 and the memories 216, 224 as being within the computing devices 204, 206, components described herein, including the processors 214, 222 and the memories 216, 224 can include multiple processors and memories that can operate in different physical locations and not within the same computing device. For example, some of the instructions 218, 226 and the data 220, 228 can be stored on a removable SD card and other instructions within a read-only computer chip. Some or all of the instructions 218, 226 and data 220, 228 can be stored in a location physically remote from, yet still accessible by, the processors 214, 222. Similarly, the processors 214, 222 can include a collection of processors that can perform concurrent and/or sequential operations. The computing devices 204, 206 can each include one or more internal clocks providing timing information, which can be used for time measurement for operations and programs run by the computing devices 204, 206.

The computing devices 204, 206 can be capable of direct and indirect communication over the network 210. The devices 204, 206 can set up listening sockets that may accept an initiating connection for sending and receiving information. The network 210 itself can include various configurations and protocols including the Internet, World Wide Web, intranets, virtual private networks, wide area networks, local networks, and private networks using communication protocols proprietary to one or more companies. The network 210 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 210, in addition or alternatively, can also support wired connections between the computing devices 204, 206, including over various types of Ethernet connection.

Although a single server computing device 204 and user computing device 206 are shown in FIG. 2, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

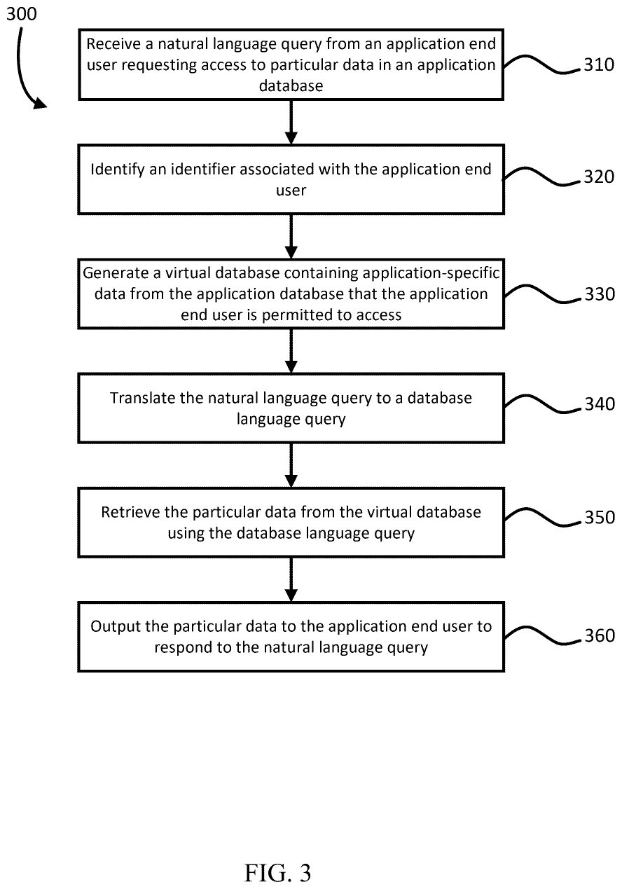

FIG. 3 depicts a flow diagram of an example process 300 for securing end user access to an application database. The example process 300 can be performed on a system with one or more processors in one or more locations, such as the application system 100 as depicted in FIG. 1.

As shown in block 310, the application system 100 receives a natural language query from an application end user requesting access to particular data in an application database.

As shown in block 320, the application system 100 identifies an identifier associated with the application end user. The identifier can be a token, numerical value, string value, and/or bit value, as examples. The identifier can be a composite or two or more identifiers. The application system 100 can generate the identifier based on the application end user being authenticated. As examples, the identifier can be a user identifier for logging into an application, a group identifier indicating a role or division within a company, and/or a composite of user and/or group identifiers, as examples. The identifier may also be a device location or time of access, as examples.

As shown in block 330, the application system 100 generates, based on the identifier, a virtual database containing application-specific data from the application database that the application end user is permitted to access. The virtual database can be a subset of the application database, containing only the application-specific data that the application end user is permitted to access. Tables of the application database may include a column or row for identifiers. The application system 100 can parse the application database and retrieve any entries from the tables that are associated with the identifier for the application end user to include in the virtual database.

As shown in block 340, the application system 100 translates the natural language query to a database language query. The natural language query can be translated to the database language query using a machine learning model, such as a large language model. The database language can be structured query language. Therefore, the application system 100 can use the large language model to translate the natural language query to structured language query, such as by using NL2SQL.

As shown in block 350, the application system 100 retrieves, using the database language query, the particular data from the virtual database. The application system 100 can parse tables in the virtual database for the particular data.

As shown in block 360, the application system 100 outputs the particular data to the application end user to respond to the natural language query.

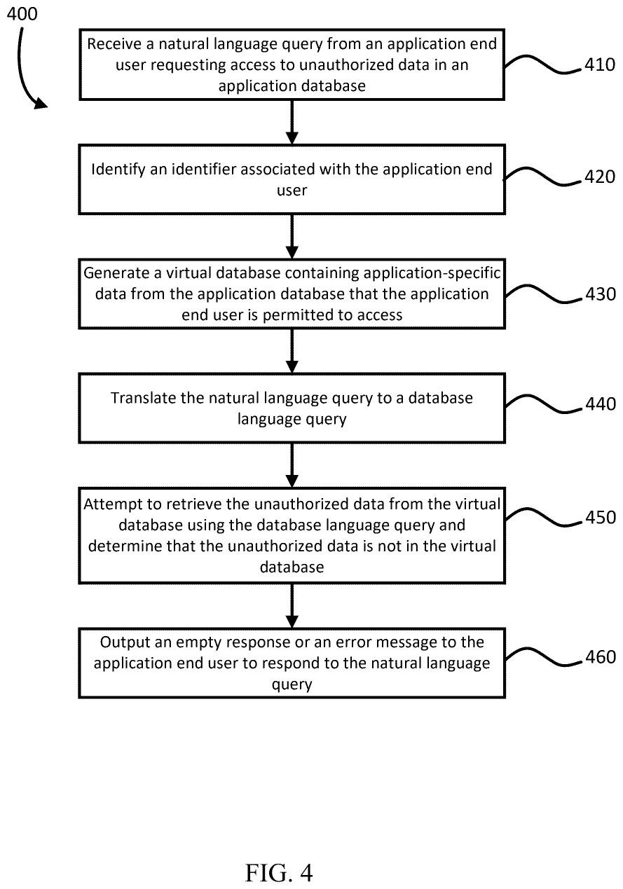

FIG. 4 depicts a flow diagram of an example process for denying end user access to unauthorized data. The example process 400 can be performed on a system with one or more processors in one or more locations, such as the application system 100 as depicted in FIG. 1.

As shown in block 410, the application system 100 receives a natural language query from an application end user requesting access to unauthorized data in an application database. Unauthorized data can refer to data in the application database that the application end user is not permitted to access.

As shown in block 420, the application system 100 identifies an identifier associated with the application end user. The identifier can be a token, numerical value, string value, and/or bit value, as examples. The identifier may also be a composite of two or more identifiers. As shown in block 430, the application system 100 generates, based on the identifier, a virtual database containing application-specific data from the application database that the application end user is permitted to access. As shown in block 440, the application system 100 translates the natural language query to a database language query. Blocks 420, 430, and 440 can correspond to blocks 320, 330, and 340 as depicted in FIG. 3.

As shown in block 450, the application system 100 attempts to retrieve the unauthorized data from the virtual database using the database language query. The application system 100 determines that the unauthorized data is not in the virtual database. The application system 100 can parse tables in the virtual database for the unauthorized data and determine that the unauthorized data is not found in the virtual database.

As shown in block 460, the application system 100 outputs an empty response or an error message to the application end user to respond to the natural language query. The empty response or error message can indicate that the application end user cannot access the unauthorized data.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the implementations should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method of securing end user access to an application database, the method comprising:
receiving, by one or more processors, a natural language query from an application end user requesting access to particular data in an application database;
identifying, by the one or more processors, an identifier associated with the application end user;
generating, by the one or more processors, based on the identifier, a virtual database containing application-specific data from the application database that the application end user is permitted to access;
translating, by the one or more processors, the natural language query to a database language query;
retrieving, by the one or more processors, using the database language query, the particular data from the virtual database; and
outputting, by the one or more processors, the particular data to the application end user to respond to the natural language query.

2. The method of claim 1, wherein the natural language query is translated to the database language query using a machine learning model.

3. The method of claim 2, wherein the machine learning model is a large language model.

4. The method of claim 1, wherein the database language is structured query language.

5. The method of claim 1, wherein the identifier is at least one of a token, numerical value, string value, or bit value.

6. The method of claim 1, wherein the identifier is a composite of two or more identifiers.

7. The method of claim 1, further comprising generating, by the one or more processors, the identifier based on the application end user being authenticated.

8. The method of claim 1, further comprising:
receiving, by the one or more processors, a second natural language query from the application end user requesting access to unauthorized data in the application database;
translating, by the one or more processors, the second natural language query to a second database language query;
attempting, by the one or more processors, using the second database language query, to retrieve the unauthorized data from the virtual database;
determining, by the one or more processors, that the unauthorized data is not in the virtual database; and
outputting, by the one or more processors, an empty response or an error message to the application end user to respond to the second natural language query.

9. A system comprising:
one or more processors; and
one or more storage devices coupled to the one or more processors and storing instructions that, when executed by the one or more processors, cause the one or more processors to perform operations for securing end user access to an application database, the operations comprising:
receiving a natural language query from an application end user requesting access to particular data in an application database;
identifying an identifier associated with the application end user;
generating, based on the identifier, a virtual database containing application-specific data from the application database that the application end user is permitted to access;
translating the natural language query to a database language query;
retrieving, using the database language query, the particular data from the virtual database; and
outputting the particular data to the application end user to respond to the natural language query.

10. The system of claim 9, wherein the natural language query is translated to the database language query using a machine learning model.

11. The system of claim 10, wherein the machine learning model is a large language model.

12. The system of claim 9, wherein the database language is structured query language.

13. The system of claim 9, wherein the identifier is at least one of a token, numerical value, string value, or bit value.

14. The system of claim 9, wherein the identifier is a composite of two or more identifiers.

15. The system of claim 9, wherein the operations further comprise generating the identifier based on the application end user being authenticated.

16. The system of claim 9, wherein the operations further comprise:
receiving a second natural language query from the application end user requesting access to unauthorized data in the application database;
translating the second natural language query to a second database language query;
attempting, using the second database language query, to retrieve the unauthorized data from the virtual database;
determining that the unauthorized data is not in the virtual database; and
outputting an empty response or an error message to the application end user to respond to the second natural language query.

17. A non-transitory computer readable medium for storing instructions that, when executed by one or more processors, cause the one or more processors to perform operations for securing end user access to an application database, the operations comprising:
receiving a natural language query from an application end user requesting access to particular data in an application database;
identifying an identifier associated with the application end user;
generating, based on the identifier, a virtual database containing application-specific data from the application database that the application end user is permitted to access;
translating the natural language query to a database language query;
retrieving, using the database language query, the particular data from the virtual database; and
outputting the particular data to the application end user to respond to the natural language query.

18. The non-transitory computer readable medium of claim 17, wherein the database language is structured query language, and the natural language query is translated to the structured query language using a machine learning model.

19. The non-transitory computer readable medium of claim 17, wherein the identifier is at least one of a token, numerical value, string value, or bit value, and the operations further comprise generating the identifier based on the application end user being authenticated.

20. The non-transitory computer readable medium of claim 17, wherein the operations further comprise:
receiving a second natural language query from the application end user requesting access to unauthorized data in the application database;
translating the second natural language query to a second database language query;
attempting, using the second database language query, to retrieve the unauthorized data from the virtual database;
determining that the unauthorized data is not in the virtual database; and
outputting an empty response or an error message to the application end user to respond to the second natural language query.
